(19) United States
(12) Patent Application Publication
(10) Pub. No.: US 2015/0066431 A1
(43) Pub. Date: Mar. 5, 2015

(54) USE OF PARTIAL COMPONENT FAILURE DATA FOR INTEGRATED FAILURE MODE SEPARATION AND FAILURE PREDICTION

(71) Applicant: General Electric Company, Schenectady, NY (US)

(72) Inventors: Yibin Zheng, Hartland, WI (US); Fang Tu, Brookfield, WI (US)

(73) Assignee: General Electric Company, Schenectady, NY (US)

(21) Appl. No.: 14/011,420

(22) Filed: Aug. 27, 2013

(51) Int. Cl. H05G 1/54

(52) U.S. Cl. CPC H05G 1/54
USPC 702/183

(57) ABSTRACT

Use of a failure model is disclosed which can be used to probabilistically evaluate possible failure modes in the event of failure of a complex component when no forensic analysis of the failed component is performed. When component failures do occur, contemporaneous sensor and operation data may be used to update and refine the failure model, whether a forensic analysis of the failed component is performed or not. Further, when no component failure is reported, the contemporaneous sensor and operation data may be used to predict component failures.

### BACKGROUND

The subject matter disclosed herein relates to the acquisition and analysis of failure data for complex electro-mechanical systems.

Many modern systems incorporate a variety of complex electro-mechanical components, each of which can fail in various manners. By way of example, an X-ray based imaging system may include as one of its components an X-ray tube which has both electrical and mechanical components and which can, therefore, fail in a variety of different ways. Similarly, the same system may also include a detector, a gantry, each of which also include various electro-mechanical components that can fail for various reasons. Historical failure data for such components may be used to predict similar failures, to design or redesign existing or new components, to plan service schedules, and to allocate limited service resources.

However such failure data is often incomplete in that the actual failure mode for a failed component is often unknown. This is primarily because the failed component, as a whole, is typically a Field Replaceable Unit (FRU), which is replaced in its entirety regardless of what the particular cause of failure is. Thus, there is generally little need to distinguish the cause of failure as the solution (i.e., replacing the FRU) will be the same. Further, the engineering resources needed analyze and diagnose failed components are typically very limited. Thus only a limited number of samples of failed components are ever fully evaluated to determine the precise cause of failure. Thus, for many components of such systems, the failure data is incomplete and often does not include the failure mode (i.e., cause of failure) for a given failed component. Absence of an identified failure mode and lack of completeness may make analysis and use of such failure data problematic.

### BRIEF DESCRIPTION

In one embodiment, a computer-implemented method for processing failure events is provided. In accordance with this embodiment, sensed parameter measurements are acquired, at a data collection system, over time from a plurality of devices remote from the data collection system. A determination is made, via execution of a processor-executed routine, whether a failure event for a component of interest within the plurality of devices has been received into an accessible data store, wherein the failure event may or may not include a mode of failure for the respective component. If a failure event has been reported and a failure mode is indicated, a failure model is updated based on the indicated failure mode and a set of contemporaneous sensed parameters for the respective device. If a failure event has been reported and a failure mode is not indicated, the failure model is updated based on a probabilistic assignment of possible failure modes and the set of contemporaneous sensed parameters for the respective device. The updated failure model is stored for subsequent use or updates

In a further embodiment, a failure analysis system is provided. In accordance with this embodiment, the failure analysis system comprises a data collection server configured to acquire sensor and operational data from one or more remote devices that comprise a component of interest and a database configured to store failure events records for the component. A plurality of the failure event records do not include an associated failure mode. The failure analysis system also comprises a failure model for the component comprising probabilities associated with a plurality of failure modes and parameters associated with the plurality of failure modes. In addition, the failure analysis system comprises a feature extraction module configured to parse the acquired sensor and operational data to generate feature vectors comprised of subsets of the sensor and operational data. The failure analysis system further comprises a control module configured to, upon entry of a failure event for a respective component to the database: update the parameters associated with a respective failure mode within the failure model using a contemporaneous feature vector if the failure event indicated the respective failure mode was known for the failure event; and update the parameters associated with each failure mode within the failure model using a contemporaneous feature vector and based on respective probabilities determined for each failure mode if the failure event does not include an indication of the failure mode.

In an additional embodiment, a non-transitory, computer-readable medium storing one or more instructions executable by a processor of an electronic device is provided. The instructions, when executed, performing acts comprising: determining whether an X-ray tube failure has been reported within one of a plurality of monitored X-ray based imaging systems; if the X-ray tube failure has been reported and a cause of X-ray tube failure is indicated, updating an X-ray tube failure model based on the indicated cause of failure and on a set of sensed parameters acquired for the respective X-ray tube contemporaneous with the X-ray tube failure; if the X-ray tube failure has been reported and the cause of X-ray tube failure is not indicated, updating the X-ray tube failure model based on a probabilistic assignment of possible causes of failure and on the set of sensed parameters; and storing the updated X-ray tube failure model for subsequent use or updates.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates one embodiment of a system for analyzing or predicting component failure events, in accordance with aspects of the present disclosure;

FIG. 2 illustrates an example of a processor-based system suitable for use as part of the system of FIG. 1;

FIG. 3 illustrates one embodiment of a failure model, in accordance with aspects of the present disclosure; and

FIG. 4 depicts a flow diagram illustrating steps and control logic that may be employed in implementing one embodiment of a failure analysis and prediction approach, in accordance with aspects of the present disclosure.

### DETAILED DESCRIPTION

The present disclosure relates to the identification and separation of failure modes of complex electro-mechanical components, such as X-ray tubes in medical CT scanners or other X-ray based imaging systems. In one embodiment, a system used to analyze failure data for such complex components is self-learning. For example, such a system may process sensor parametric data that is automatically collected during operation of a device incorporating one or more complex electro-mechanical components and may also utilize incomplete failure mode data that is manually collected (i.e., data reported by field or service engineers).

One such system discussed herein addresses the practical difficulties of collecting forensic ground truth data for component failures. An example of such a system may utilize unsupervised clustering and supervised training, utilizing limited failure mode data to facilitate failure classification, as well as determining decision boundaries for failure and non-failure events. In one embodiment, while learning failure modes, the system monitors device failures in real time, such as via sensor data collected and aggregated from systems in operation.

As discussed herein, without sufficiently complete failure mode data for known failure events, it may be difficult or to train the failure prediction algorithms correctly. For example, the feature vectors associated with distinct failure modes may be very different. If an automated learning process is constrained to only complete data, the number of samples may be insufficient and the failure signatures may not be estimated reliably. The present approach addresses this problem by taking advantage of the large number of failure samples without ground truth failure mode data, i.e., by using incomplete failure data. For example, in one implementation, a “soft” failure mode (i.e., an estimated or guessed failure mode that is not confirmed by forensic or diagnostic analysis by an engineer) may be assigned to each failure. In one such implementation, the parameters of each failure mode are estimated separately. The parameters of distinct failure modes are then used to re-estimate the “soft” failure modes of each sample, until self-consistency is achieved. In this manner, each failure mode is influenced by the data most likely associated with it, and mixing of failure modes is avoided.

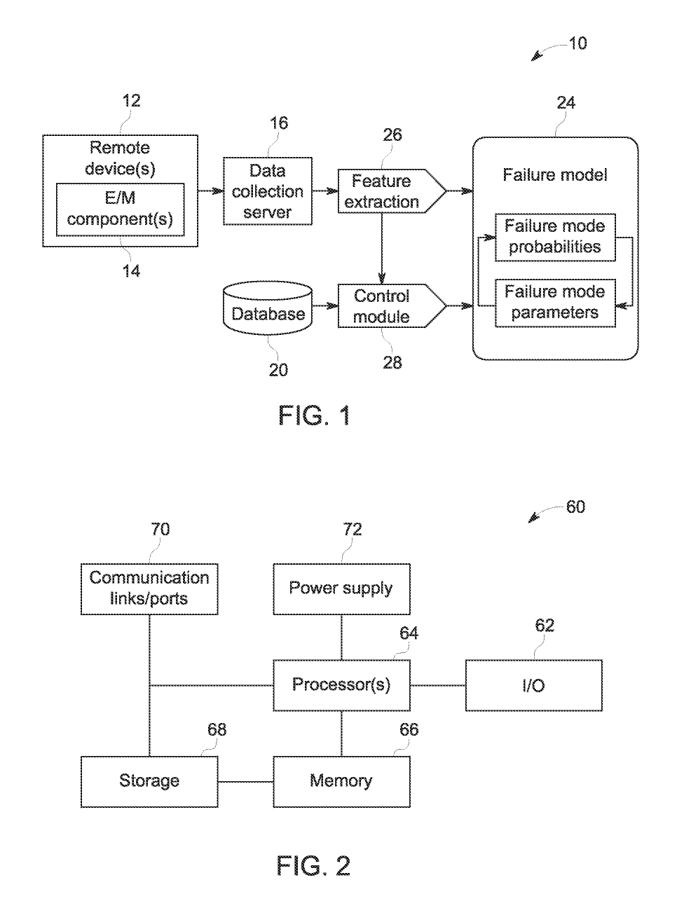

With the preceding in mind, and turning to FIG. 1, one implementation of the present approach may include a variety of subsystems. For example, such a system 10 may include one or more devices 12, typically remote from the other devices or subsystems, that include or utilize one or more electro-mechanical components 14 that are being monitored. The electro-mechanical components 14 of the devices 12, in accordance with present embodiments, are monitored for failure and/or are the subject of failure prediction routines.

The device 12 include one or both of sensors and software to record parametric and event data related to the operation of the component 14. For example, operational data related to the component 14 may be recorded that includes physical parameters (i.e., electrical and/or mechanical parameters) of the component 14 when in use or at rest as well as event data indicating what operations are performed and when by the device 12 and/or component 14. The event data will typically be relatable to the measured physical parameters by time stamp or other correlating data stamp. By way of example, a device 12 may be an imaging system, such as a computed tomography (CT) imaging system or other X-ray based imaging system, and a component 14 may be an X-ray tube (or other electro-mechanical component) of the imaging system.

The depicted example of an implementation also includes one or more data collection servers 16 (e.g., a back-office server or other processor-based system) in communication with the remote devices 12. The data collection server 16, in this example, automatically collects the sensor and operational data (e.g., the physical parameter data and event data) automatically. Typically, for each device 12, data are aggregated over a time window ranging from a few minutes to a few days.

Turning to FIG. 2, the data collection server 16 (or other processor-based components of the system 10) may be provided as any suitable processor-based system 60. By way of example, FIG. 2 is a block diagram depicting various components that may be present in a suitable processor-based system 60. As will be appreciated, the various functional blocks shown in FIG. 2 may comprise hardware elements (including circuitry), software elements (including computer code stored on a computer-readable medium), or a combination of both hardware and software elements to perform the functions discussed herein related to failure mode analysis. In the presently illustrated embodiment, components of a processor-based system 60 may include, but are not limited to: input/output (I/O) interfaces and devices 62 (e.g., displays, keyboards, mice, touchpads, touchscreens, printers, and so forth), one or more processors 64 (e.g., a CPU or other microprocessor), memory components 66, a non-volatile storage 68, one or more communication links or ports 70 (e.g., network or Internet communication links), and a power source 72.

The processor(s) 16 may provide the processing capability to execute routines for performing the failure mode analyses discussed herein. The instructions or data to be processed by the processor(s) 16 may be stored in a computer-readable medium, such as a memory 66 and/or storage 68. For example, the physical parameter and/or event data from the remote devices 12, the database 20 as discussed below, and/or routines encoding analyses discussed herein may be stored on one or both of the storage 68 or memory 66 for use by the processor 64.

With this in mind, and turning back to FIG. 1, the depicted example of a system 10 also includes a database(s) 20 (e.g., a back-office database or other accessible electronic data storage) that contains reported component failure histories, failure modes, and detailed failure data for each device (e.g., reported component failure time stamps and failure modes traceable to devices 12 and components 14). Typically, the data entries are manually collected and may, therefore, incur a delay of hours to days. For example, reporting of a failure event may include a field engineer, a service engineer, or an on-site user entering a failure event occurs directly into the database 20 or filing a paper or electronic report that is subsequently entered into the database 20. Further, the failure data recorded in the database 20 are typically incomplete in that failure modes and associated parametric data are not known for many, if not the majority, of failure samples. The database(s) 20 may be stored on the data collection serve 16 or on other suitable processor-based systems in communication with the system 10.

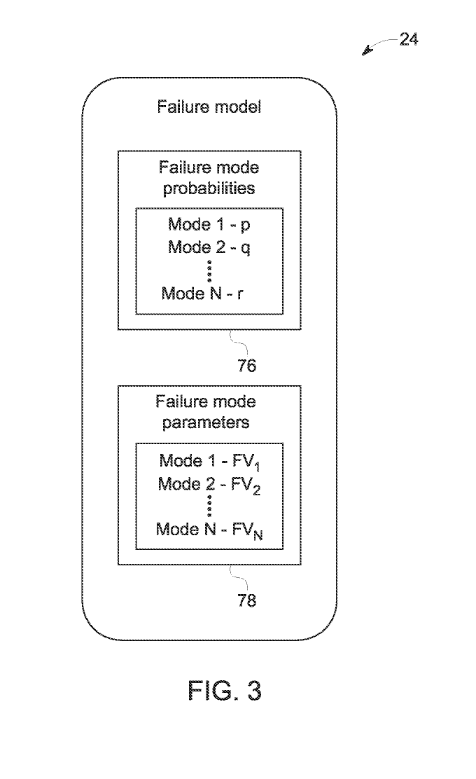

One or more analytic routines and models, such as the depicted failure model 24, feature extraction routine 26, and control module 28, may be used to process the data aggregated by the data collection server (i.e., the physical parameters and event data for remote devices 12) as well as the component failure data stored in database 20. With this in mind, the various analytics and models depicted may run on the same processor-based system (e.g., computer or server) or may be distributed on several networked computers. With respect to the failure model 24, FIG. 3 depicts an example of one such model. In this example, a parameterized failure probabilistic model 24 is depicted which, given failure of a component 14, provides for the categorization of the failure to one of several specific failure modes (e.g., causes or failure). In the failure model 24, each failure mode associated with a failure of a component 14 is characterized by its probability of occurrence (block 76) and by its respective physical parameters (block 78) (e.g., electrical or mechanical characteristics observable in the sensor data monitored for the device 12). By way of example, in one embodiment, the physical parameters for each failure mode are characterized by a respective parameterized probability density function of feature vectors.

By way of example, and returning to the CT imaging context used above as an example, in the case of an X-ray tube failure in a CT imaging system, X-ray tube failures can be characterized or distinguished based on the mechanism of failure (i.e., the failure mode). These X-ray tube failure modes may include (but are not limited to): rotor failure, high voltage failure, and filament failure. With respect to the failure mode probabilities 76, empirical evidence may be used to determine a respective probability associated with each of these failure modes (e.g., a 40% probability of rotor failure, a 50% probability of high voltage failure, and a 10% probability of filament failure.

Separate from this information, the physical parameters 78 related to the respective X-ray tube failure modes may include: rotor current, spit rate, and filament current, and so forth, all of which may be parameters measured at the device 12 during operation (or at rest in some cases). These parameters 78 may be used to form or characterize a feature vector (i.e., FV₁-FV_{N} in FIG. 3) for each of the respective failure modes (i.e., Mode 1-Mode N in FIG. 3). Each component of a respective feature vector for a given failure mode has a probability distribution function further characterized by statistical parameters. For example, in the present X-ray tube failure example, the rotor current parameter may be characterized by a Gaussian distribution function of certain mean and variance, while the spit rate parameter may be characterized by an Exponential distribution with a certain rate. Thus, as used herein, the failure model 24 may characterize each failure mode modeled both in terms of observed probability and by feature vectors based on the measured parameters (and their respective probabilistic distributions) for the component 14 of interest.

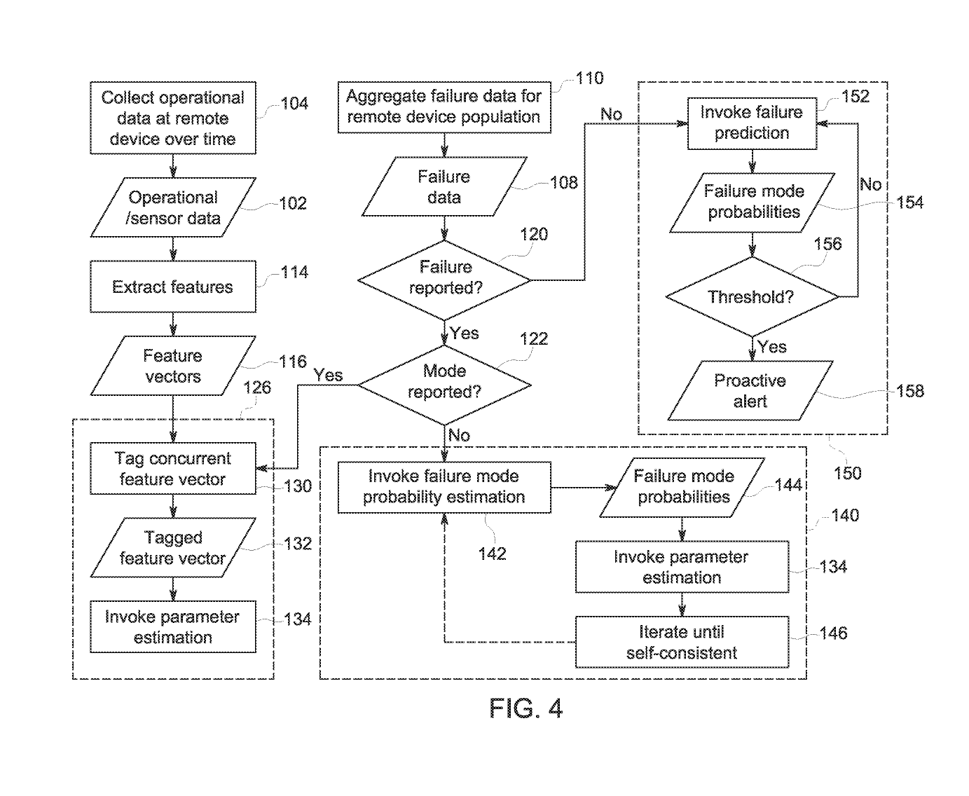

Turning to FIG. 4, a walk-through of one such implementation is provided. In the depicted flow diagram 100, and as discussed above, operational and/or sensor data 102 is collected (block 104) for remote devices 12 having one or more electro-mechanical components 14 undergoing that are being monitored. As noted above, the operational and/or sensor data 102 may be aggregated over time and is indicative of the physical parameters of interest for the electro-mechanical components 14 as well as of event and/or operational data of interest (such as when the device 12 is on or off and/or what types of operational protocols (e.g., examination protocols) are applied and when).

Also as discussed above, failure data 108 is acquired (block 110) for the population of devices 12. The failure data 108 may be corresponding to failure event data submitted by users of the devices 12 or by field or system engineers who service the devices 12. For example, when a field engineer replaces a FRU, such as an X-ray tube or other electro-mechanical component 14, the field engineer may submit a failure report indicating the date and time of the failure event, the part replaced, and any other pertinent circumstances that may be recorded for the failure event. In certain instances, the failed component 14 may undergo further analysis and a ground truth failure mode may be determined and recorded as part of the failure data 108. But in many, if not most, instances, the failure data 108 will be incomplete for a failure event in that no failure mode for the failed electro-mechanical component 14 will be explicitly determined by analysis of the component 14.

As depicted in FIG. 4, the operational/sensor data 102 and failure data 108 may be used in a logic-driven analytic framework. For example, in the depicted example, an analytics implementation (such as may be implemented in a back-office analytics system) may comprise a number of distinct modules or subroutines. For example, a feature extraction module 26 (see FIG. 1) may extract (block 114) feature vectors 116 from the raw operational/sensor data 102 specific to the component of interest and aggregated over a time interval of interest. In one implementation, the feature vectors 116 are reduced dimension data sets, as compared to the total aggregated operational/sensor data 102, and may therefore consist of only some subset of components or constituent measurements relative to the total set of measured data components in the operational/sensor data 102. For example, if one hundred parameters are routinely monitored for each device 12 or component 14, a representative feature vector may consist of those ten parameters determined to be most useful in analyzing the failure or performance of the respective component 14. The extracted feature vector 116 may be representative of or averaged over a time frame of interest, such as the last thirty minutes, hour, 6 hours, 12 hours, day or week. As part of the feature extraction process 114 various other data processing functions may occur, such as removal of outliers, smoothing of the data, and so forth.

By way of example, an implementation of the feature extraction module 26 may include one or more of the following components: a parser, a de-noising filter, a smoother, or a transformer. In such an example, the parser, if present may extract (i.e., parse) parameters of interest from raw log files of the operational/sensor data 102. The filter, if present, may remove blank (i.e., null or void data points) and/or out-of-bound or other invalid data points. The smoother, if present, may attempt to remove spurious spikes and other noise in the data, such as by taking the median of the data over a period of time. The transformer, if present, may convert data to a different domain more suitable for decision making, for example, from time domain to frequency domain (i.e., a Fourier transformation).

With respect to the failure data 108, in one implementation a control module 28 (see FIG. 1) may, in real-time or on a periodic basis (i.e., within a time window of interest) check to determine if a failure event has been reported or otherwise received (block 120) for a component of interest 14, such as by accessing the database 20 and searching for newly reported failure events. In the event a failure of a component of interest 14 has been reported, an additional determination may be made (block 122) as to whether a failure mode has been determined and reported. By way of example, in the context of a CT imaging system, the control module 28 may periodically check to determine whether an X-ray tube failure has been reported by a field engineer or customer since the last check and, if so, whether a failure mode has been diagnosed.

In the event a failure is reported and the failure mode is determined or known (such as by forensic analysis), the steps outlined by dashed box 126 may be performed. In particular, in the depicted example, a feature vector 132 concurrent with this failure is identified (i.e., tagged) (block 130) for the known failure mode. That is, an identified or tagged feature vector 132 is determined that corresponds to the timing of the failure. Thus, the tagged feature vector 132 corresponds to the measured or sensed physical parameters of the component 14 at the time of the failure.

In the depicted example, once the identified feature vector 132 is determined, a failure mode parameter estimation module is invoked (block 134). In one implementation, the failure mode parameter estimation module or routine analyzes the samples identified as having a particular failure mode and estimates statistical parameters associated with the failure mode based on these samples. As a result, the failure mode parameters 78 of the failure model 24 may be updated as new samples are identified and contribute to the analysis. The updated failure model may then be stored for future use or updates or may be output (e.g., printed or displayed) for review by a user.

In the present context, where the failure mode is known and unambiguous (such as due to an engineering or other determinative forensic analysis), the failure mode identification may be deemed a “hard” identification. In such circumstances, the samples may be given greater weight in the parameter estimation process used to update the failure mode parameters 78. For example, in the event of an X-ray tube failure in a CT imaging system, if the failure mode is known (such as by forensic analysis) to be a high voltage failure, then the spit rate (i.e., one of the measured physical parameters) of the failure event in question may be fully (i.e., 100%) attributed to the high voltage failure sample pool when estimating the expected spit rate for high voltage failures.

In contrast to the above scenario where the failure mode is known, if a failure is reported but the failure mode is unknown, a different operational path may be performed, as outlined by dashed box 140. In this example of an implementation, a failure mode probability estimation module or routine may be executed (block 142) which determines respective probabilities 144 of different failure modes for a given failure event. In particular, for a given failure event, the probabilities of each failure mode being the cause of the failure event are estimated. These probabilities constitute a “soft” identification of the failure mode for the current failure event as there is less than absolute certainty as to the ground-truth failure mode. In one implementation, the estimated probabilities depend on the feature vectors 116 associated with the failure event in question and the failure mode parameters 78 of the failure model 24. For example, if an X-ray tube of a CT imaging system has failed, then based on the operational/sensor data 102 for this failure and the current statistical parameters 78 for each failure mode used in the failure model 24, the failure mode probability estimation module may estimate that the failure is 70% probability a rotor failure, 25% probability a high voltage failure, and 5% probability a filament failure.

In the depicted implementation, based on this “soft” failure mode identification, the failure mode parameter estimation module or routine is executed (block 134). As discussed above, this routine updates the statistical parameters 78 for the failure modes in the failure model 24. Unlike instances where there is a “hard” or certain identification of the failure mode, for samples where the failure mode is probabilistically inferred (i.e., a “soft” identification), less weight may be given in the parameter estimation process. For example, in certain implementations, samples are weighted proportionally based on the probability that the failure in question corresponds to a given failure mode. Thus, if a failure mode for a sample is deemed to be 60% likely to be a rotor failure, 30% likely to be a high voltage failure, and 10% likely to be a filament failure, the sample in question may be correspondingly weighted when used in the parameter estimation process to update the respective failure mode parameters 78. Thus, the statistical parameters 78 of failure modes will, in certain implementations, be updated based on the feature vectors 116 and the probabilities associated with the “soft” failure modes.

In the depicted implementation, the updated failure mode parameters 78 are used to re-estimate (block 146) the “soft” failure mode identification, i.e., to reassess the probabilities assigned to each possible failure mode for a given failure event. This process may be repeated until self-consistency is achieved or some other termination criterion is met. The final result is the best estimate of the failure mode for a given failure event given all available information. In certain implementations, the estimate (i.e., the “soft” identification) is again updated when new data arrive and the failure model parameters 78 of the failure model 24 are again updated.

As will be appreciated by the above discussion, this approach solves the problems associated with having too few samples of component failures where failure mode is known (such as due to engineering analysis) and allows use of even those samples where the failure mode is unknown or uncertain to update or refine a given failure model. By generating a “soft” identification of failure mode for each failure of a component 14 where a forensic analysis is not performed, the present approach estimates the parameters of each failure mode separately. The parameters of distinct failure modes may then be used to re-estimate the “soft” failure modes of each sample, until self-consistency is achieved. In this manner, each failure mode is influenced by the data most likely associated with it, and mixing of failure modes may be avoided.

While the preceding discussion addresses scenarios where a failure event has occurred (block 120), in instances where no failure event is reported, a different operational path may be performed, as outlined by dashed box 150. For example, in the depicted example, if no failure is reported, a monitoring and failure prediction module or routine may be executed (block 152). In accordance with one embodiment, the failure prediction routine may calculate, for a component 14, the probabilities 154 of each failure mode based on current failure mode parameters 78 of the failure model 24 and on the current feature vector 116 for the respective device 12. In one implementation, if any of the probabilities is above a threshold (block 156), a proactive failure alert 158 is generated which may be displayed, printed, or audibilized, such as by one of the I/O devices 62 of FIG. 2 e.g., a monitor, printer, or speaker). If not, monitoring may continue until a failure is reported or a prediction threshold is exceeded.

In contrast to the failure mode probability estimation module discussed, above, which estimates the probabilities of each failure mode in the event a failure has occurred (but not been diagnosed), failure is not assumed to have occurred when the prediction module is invoked. Therefore the failure mode probabilities generated by the prediction module will not necessarily (and likely won't) sum to one. For example, given the current sensor data (as extracted into feature vectors 116), the failure prediction module may estimate that there is 10% probability that an X-ray tube being monitored has failed due to rotor failure, and a 20% probability the X-ray tube has failed due to high voltage failure, with a 40% probability that the X-ray tube has not failed yet.

Thus, as will be appreciated, the present approach provides for the use of a failure model that can be used to probabilistically evaluate possible failure modes in the event of failure of a complex electro-mechanical component when no forensic analysis of the failed component is performed. When component failures do occur, the contemporaneous sensor and operation data may be used to update and refine the failure model, whether a forensic analysis of the failed component is performed or not. Further, when no component failure is reported, the contemporaneous sensor and operation data may be used to predict component failures.

Technical effects of the invention include use of an automated system to identify failure modes of complex electro-mechanical components. Sensor parametric data may be used to probabilistically infer a failure mode in the event of a component failure or to predict component failures in the event no failure has been reported. In the event of a component failure, a failure model employed by the system may be updated and refined, regardless of whether the failed component has undergone a forensic engineering analysis. Monitoring of remote devices for component failures may occur in real-time based on the sensed parametric data.

Commercial advantages of the present approach include, but are not limited to: accurate and consistent predictive failure alerts and proactive service to help reduce unplanned equipment downtime; reduction in service costs; and prolonged equipment life. Technical advantages of the present approach include, but are not limited to: use of a failure mode model, which prevents mixing of failure data attributable to different root causes. Further, by using samples with complete and incomplete data together, the quality of parameter estimation is improved without the need to manually collect complete failure data for each sample. In addition, by making soft identifications of probable failure modes, the system accounts for uncertainty and incompleteness of the current decision. Thus marginally incorrect decisions will have only limited adverse impact on parameter estimates of the failure modes. Further, the estimation of failure modes based on real-time data can allow for the generation of real-time proactive failure alerts

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for processing failure events, comprising the acts of:
acquiring, at a data collection system, sensed parameter measurements over time from a plurality of devices remote from the data collection system;
determining, via execution of a processor-executed routine, whether a failure event for a component of interest within the plurality of devices has been received into an accessible data store, wherein the failure event may or may not include a mode of failure for the respective component;
if the failure event has been reported and a mode of failure is indicated, updating a failure model based on the indicated mode of failure and a set of contemporaneous sensed parameters for the respective device;
if the failure event has been reported and the mode of failure is not indicated, updating the failure model based on a probabilistic assignment of possible modes of failure and the set of contemporaneous sensed parameters for the respective device; and
storing the updated failure model for subsequent use or updates.

2. The computer-implemented method of claim 1, wherein the sensed parameter measurements are a subset of a larger set of sensed measurements acquired from the plurality of devices.

3. The computer-implemented method of claim 1, wherein the probabilistic assignment of possible modes of failure is determined based upon the set of contemporaneous sensed parameters and the failure model.

4. The computer-implemented method of claim 1, further comprising iteratively updating the probabilistic assignment of possible modes of failure and the failure model until a stable solution is attained.

5. The computer-implemented method of claim 1, further comprising:
if the failure event has not been reported, deriving a probability of failure for each mode of failure for a respective component using the set of contemporaneous sensed parameters and the failure model.

6. The computer-implemented method of claim 5, further comprising:
determining whether one or more of the probabilities exceeds a specified threshold; and
displaying an alert if the specified threshold is exceeded.

7. The computer-implemented method of claim 1, wherein the component of interest comprises a field replaceable unit.

8. The computer-implemented method of claim 1, wherein the failure model comprises:
a set of probabilities associated with each mode of failure; and
a set of sensed parameters associated with each mode of failure.

9. A failure analysis system, comprising:
a data collection server configured to acquire sensor and operational data from one or more remote devices that comprise a component of interest;
a database configured to store failure events records for the component, wherein a plurality of the failure event records do not include an associated failure mode;
a failure model for the component comprising probabilities associated with a plurality of failure modes and parameters associated with the plurality of failure modes;
a feature extraction module configured to parse the acquired sensor and operational data to generate feature vectors comprised of subsets of the sensor and operational data; and
a control module configured to, upon entry of a failure event for a respective component to the database:
update the parameters associated with a respective failure mode within the failure model using a contemporaneous feature vector if the failure event includes indicated the respective failure mode was known for the failure event; and
update the parameters associated with each failure mode within the failure model using a contemporaneous feature vector and based on respective probabilities determined for each failure mode if the failure event does not include an indication of the failure mode.

10. The failure analysis system of claim 9, wherein the probabilities determined for each failure mode are determined using the contemporaneous feature vector and the failure model.

11. The failure analysis system of claim 9, wherein the control module, if no failure event is entered, is further configured to derive a probability of failure for each failure mode for one or more of the components using the contemporaneous feature vector and the failure model.

12. The failure analysis system of claim 11, wherein the control module:
compares the derived probabilities of failure to one or more respective thresholds; and
if the threshold is exceeded, generates an alert.

13. The failure analysis system of claim 9, wherein the control module iteratively updates the respective probabilities and the failure model until self-consistent.

14. The failure analysis system of claim 9, wherein the data collection server, the database, the failure model, the feature extraction module, and the control module are implemented on one or more processor-based systems.

15. The failure analysis system of claim 9, wherein the component of interest comprises a field replaceable unit of the remote devices.

16. A non-transitory, computer-readable medium storing one or more instructions executable by a processor of an electronic device, the instructions, when executed, performing acts comprising:
determining whether an X-ray tube failure has been reported within one of a plurality of monitored X-ray based imaging systems;
if the X-ray tube failure has been reported and a cause of X-ray tube failure is indicated, updating an X-ray tube failure model based on the indicated cause of failure and on a set of sensed parameters acquired for the respective X-ray tube contemporaneous with the X-ray tube failure;
if the X-ray tube failure has been reported and the cause of X-ray tube failure is not indicated, updating the X-ray tube failure model based on a probabilistic assignment of possible causes of failure and on the set of sensed parameters; and
storing the updated X-ray tube failure model for subsequent use or updates.

17. The non-transitory, computer readable medium of claim 16, wherein the set of sensed parameters acquired for the respective X-ray tube contemporaneous with the X-ray tube failure are a subset of a larger set of sensed measurements.

18. The non-transitory, computer readable medium of claim 16, wherein the probabilistic assignment of possible causes of failure is determined based upon the set of sensed parameters and the X-ray tube failure model.

19. The non-transitory, computer readable medium of claim 16, wherein the instructions, when executed, performing further acts comprising:
iteratively updating the probabilistic assignment of possible causes of failure and the X-ray tube failure model until a stable solution is attained.

20. The non-transitory, computer readable medium of claim 16, wherein the instructions, when executed, performing further acts comprising:
if the X-ray tube failure event has not been reported, deriving a probability of X-ray tube failure for each cause of failure for component respective X-ray tube using the set of sensed parameters and the X-ray tube failure model; and
generating an alert if the one or more of the probabilities exceeds a specified threshold.
